(19) United States
(12) Patent Application Publication
(10) Pub. No.: US 2013/0088184 A1
(43) Pub. Date: Apr. 11, 2013

(54) Battery device utilizing oxidation and reduction reactions to produce electric potential

(71) Applicants: Fu-Tzu HSU, Taipei City (TW); Chieh-Sen TU, New Taipei City (TW)

(72) Inventors: Fu-Tzu HSU, Taipei City (TW); Chieh-Sen TU, New Taipei City (TW)

(21) Appl. No.: 13/267,148

(22) Filed: Oct. 6, 2011

(51) Int. Cl. H02J 7/00

(52) U.S. Cl. 320/103

(57) ABSTRACT

A battery device utilizing oxidation and reduction reactions to produce electric potential includes a battery jar unit, an electrocatalytic unit, a buffer battery unit, and a rectifying and charging unit. The battery jar unit includes a salt solution as electrolyte, an anode formed of a metal not chemically reacting with the electrolyte, and a cathode formed of an electrically conductive carbon material having breathing pores, so that the carbon material breathes air and releases negative hydroxide ions when the air dissolves in the electrolyte. The electrocatalytic unit provides an electrochemical damping effect that catalyzes generation of electricity in the battery jar unit, and the rectifying and charging unit converts the generated AC current into DC current and charges the same to the buffer battery unit, so that an electricity-generating battery based on electrical resonance effect is formed. With these arrangements, a poison-free, waste-heat-free, noise-free and zero-emission self-power-generating battery is achieved.

### FIELD OF THE INVENTION

The present invention relates to a battery device utilizing oxidation and reduction reactions to produce electric potential, and more particular to a battery device that employs electrocatalytic technique to use positive electrochemical damping effect to cause oxidation reaction and generation of electricity, and use negative electrochemical damping effect to cause reduction reaction, so as to form a closed-loop physical resonance circuit in the battery to achieve one-hundred percent zero-pollution and zero-emission green energy source.

### BACKGROUND OF THE INVENTION

A fuel cell is a device that uses chemical reactions to generate electricity. In the fuel cell, hydrogen and oxygen are directly combined to produce water, and energy released in the chemical reaction of forming water from hydrogen and oxygen is electric energy. Batteries can be generally divided into acid batteries and alkaline batteries. According to the Arrhenius Theory of acids and bases, a compound is alkaline if its water solution in an ionization process creates hydroxide ions (OH⁻) without producing other anions. That is, an alkaline compound provides hydroxide ions (OH⁻) or absorbs hydrogen ions (H⁺). The ionization is a physical process of converting an atom or molecule into an ion under an energy effect. On the other hand, a compound is acid if its water solution has a hydrogen ion (H⁺) concentration larger than that in pure water. That is, an acid compound, when dissolves in water, will release cations that all are hydrogen ions (H⁺). Or, a compound that is an electron (e⁻) acceptor is an acid compound. Thus, the oxygen ion (O₂⁻) is the conjugate base of the hydroxide ion (OH⁻) as represented below:

O₂⁻+H₂O→2OH⁻

Please refer to FIG. 2. To use hydrogen and oxygen as the fuels in the electrochemical process of a fuel cell, first electrolyze pure water 20. At this point, the anode releases electrons as an oxidation reaction and the cathode receives electrons as a reduction reaction. This process is referred to as an electrolysis reaction. In FIG. 2, the anode is formed of zinc oxide (ZnO) 21 and the cathode is a carbon rod 22, and the arrow 23 indicates the charge flow direction. The reactions are represented by the following chemical equations:

Anode: 2H₂O→O₂+4H⁺+4e⁻

Cathode: 2H₂O+2e⁻→H₂+2OH⁻

Overall electrolysis reaction: 2H₂O→2H₂+O₂

In a reverse electrolysis reaction, hydrogen is added to the anode and oxygen is added to the cathode to produce pure water, electromotive force and heat (i.e. steam), as is found in a hydrogen-oxygen fuel cell stack. The reactions are represented by the following chemical equations:

Anode: H₂→2H⁺+2e⁻ Ea: 0V

Cathode: O₂+4H⁺+4e⁻→2H₂O Ec: 1.22PV

Overall reverse electrolysis reaction: 2H₂+O₂→2H₂O+heat Ec−Ea=1.22PV

The electrolysis is a chemical reaction indicating a process in which oxidation and reduction reactions occur at cathode and anode when an electrolyte is under an energy effect. In causing electrolysis in a metal-air fuel cell stack, when different metals are used as two electrodes, the battery is an acid battery; and when only one type of metal is used as one of the electrodes, the battery is an alkaline battery. Please refer to FIG. 1. The electrolysis process occurred in an alkaline zinc-air fuel cell stack is represented by the following chemical equations:

Anode: Zn+2OH⁻→ZnO+H₂O+2e⁻ Ea: 0V

Cathode: O₂+2H₂O+4e⁻→4OH⁻ Ec: 1.22PV

Charge reaction: 2Zn+O₂→1ZnO Ec−Ea=1.22PV

In the above chemical reactions, there are produced electromotive force as well as pure water and heat; the electrolyte 10 is potassium hydroxide (KOH), and absorption of carbon dioxide (CO₂) will occur in the process to cause failure of the fuel cell. In FIG. 1, the anode is a zinc plate 11, and the cathode is a carbon rod 12. In FIG. 1, the cathode is denoted by letter ‘K’ while the anode is denoted by letter ‘A’, and the arrow 13 indicates the electron flow direction.

### SUMMARY OF THE INVENTION

The present invention provides a battery device that utilizes oxidation and reduction reactions to produce electric potential. The battery device includes a battery jar unit, an electrocatalytic unit, a buffer battery unit, and a rectifying and charging unit.

The battery jar unit includes a salt solution as an electrolyte, an anode formed of a metal not chemically reacting with the electrolyte, and a cathode formed of an electrically conductive carbon material with breathing pores, so that the carbon material breathes air and releases negative hydroxide ions when the air dissolves in the electrolyte.

The electrocatalytic unit is a catalyst producing an electrochemical damping effect and is used to catalyze oxidation reaction and reduction reaction in the battery jar unit. The electrocatalytic unit includes a pulse generator, an electron release circuit, and a charge release circuit. The pulse generator is able to generate positive and negative pulses; the positive pulse activates the charge release circuit to release charges, and the negative pulse activates the electron release circuit to release electrons. When the electrocatalytic unit releases electrons into the battery jar unit, a reverse electrolytic reduction reaction occurs in the battery jar unit to cause a potential difference between the anode and the cathode of the battery jar unit, and when the electrocatalytic unit releases charges into the battery jar unit, an electrolytic oxidation reaction occurs in the battery jar unit to cause a potential difference between the anode and the cathode of the battery jar unit.

The buffer battery unit is a rechargeable battery that can be repeatedly charged and discharged.

The rectifying and charging unit is capable of converting AC potential output by the battery jar unit into DC potential, and supplies the DC potential to the buffer battery unit for charging same.

In implementing the present invention, the chemical damping effect of the electrons released by the electrocatalytic unit causes oxidation reaction and generation of electricity, and the chemical damping effect of the charges released by the electrocatalytic unit causes reduction reaction and generation of electricity.

In the present invention, the charges and the electrons released by the electrocatalytic unit have a 180-degree phase difference between them.

In the present invention, the electron release circuit of the electrocatalytic unit includes a transistor for converting frequency into electrons, an electrical damping resonant tank, and a booster transformer.

In the present invention, the charge release circuit of the electrocatalytic unit includes a transistor for converting frequency into charges, an electrical damping resonant tank, and a booster transformer.

According to the present invention, the metal for forming the anode of the battery jar unit is selected from the group consisting of copper, zinc, and lithium alloy.

According to the present invention, the carbon material for forming the cathode of the battery jar unit is selected from the group consisting of graphite, carbon rod, carbon nanotubes, and carbon fibers.

According to a preferred embodiment of the present invention, the electrolyte in the battery jar unit is neutral seawater.

In an embodiment of the present invention, the buffer battery unit is selected from the group consisting of a rechargeable acid battery and a rechargeable alkaline battery.

In another embodiment of the present invention, the buffer battery unit is selected from the group consisting of a rechargeable acid battery, a rechargeable alkaline battery, and a resonant battery formed by parallelly connecting a rechargeable acid battery and a rechargeable alkaline battery.

In an embodiment of the present invention, the rectifying and charging unit is an AC to DC converter.

And, in the present invention, the electrocatalytic unit obtains its operating power from the buffer battery unit.

In brief, the battery device of the present invention utilizes oxidation and reduction reactions to produce electric potential. The battery device of the present invention employs the negative electrochemical damping effect produced by the electrocatalytic unit to cause the reduction reaction, so that a closed-loop physical resonance circuit is formed in the battery jar unit. Since chemical changes are replaced by physical reactions in the battery of the present invention, a one-hundred percent zero-pollution and zero-emission renewable or green energy source can be achieved. Moreover, the AC potential produced in the present invention through oxidation (charging) reaction and reduction (discharging) reaction can be converted by the rectifying and charging unit into DC potential, which is then supplied to the buffer battery unit for charging same, allowing the present invention to provide increased benefit of self-power generation.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual diagram of zinc-air fuel cell stack;

FIG. 2 is a conceptual diagram of a conventional hydrogen-oxygen generator;

FIG. 3 is a block diagram of a battery device according to the present invention;

FIG. 4 is a conceptual diagram of a battery jar unit included in the battery device of the present invention;

FIG. 5 is a circuit diagram of an electrocatalytic unit included in the battery device of the present invention;

FIG. 6 is an equivalent-circuit diagram of a rechargeable acid battery;

FIG. 7 is an equivalent-circuit diagram of a rechargeable alkaline battery; and

FIG. 8 is an equivalent-circuit diagram of a resonating battery.

### DETAILED DESCRIPTION OF THE PREFERRED EMBODIMENTS

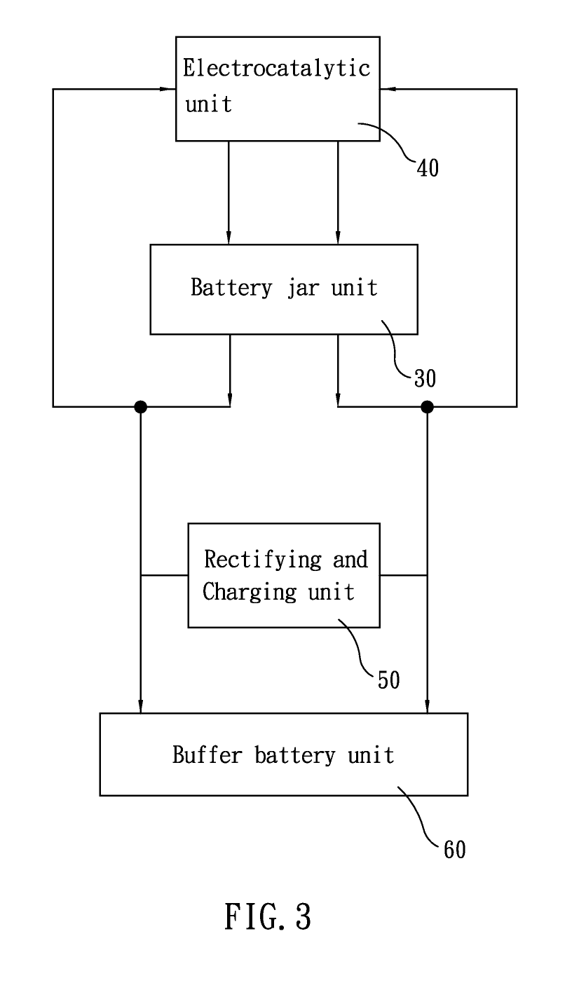

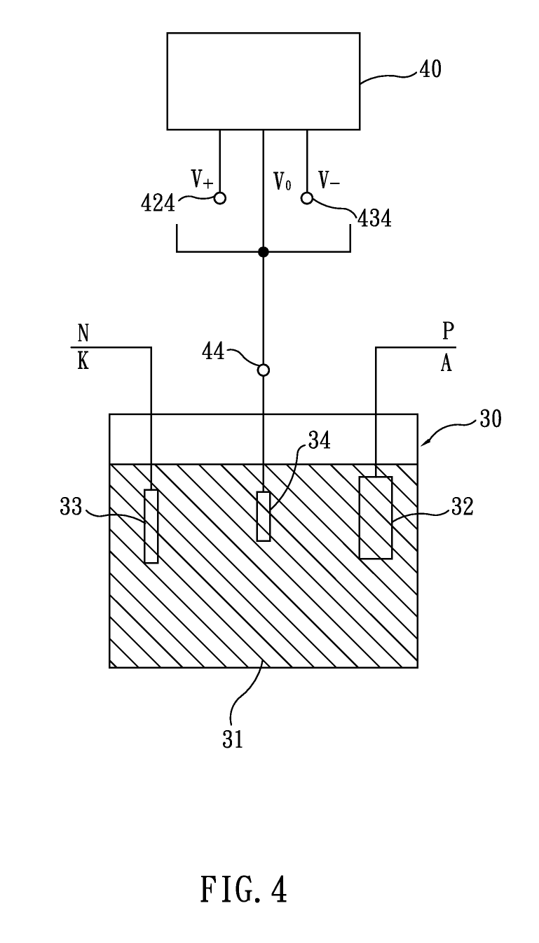

Please refer to FIGS. 3 and 4. The present invention relates to a battery device that uses a metal-air fuel cell stack to generate renewable energy, and more particularly to a battery device that utilizes oxidation and reduction reactions to produce electric potential. As shown, in FIG. 3, the battery device according to the present invention includes a battery jar unit 30, an electrocatalytic unit 40, a rectifying and charging unit 50, and a buffer battery unit 60.

The battery jar unit 30 includes a salt solution as an electrolyte 31, an anode 32 formed of a metal that does not chemically react with the electrolyte 31, and a cathode 33 formed of an electrically conductive carbon material having breathing pores. The carbon material is able to breathe air and to release hydroxide ions when the air dissolves in the electrolyte 31.

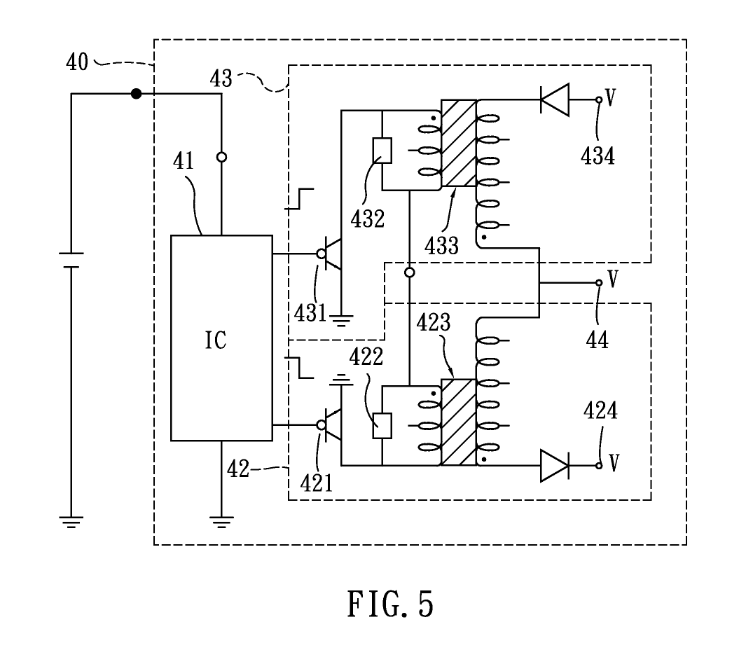

Please refer to FIG. 5. The electrocatalytic unit 40 is a catalyst producing electrochemical damping effect, and is used for catalyzing oxidation reaction and reduction reaction in the battery jar unit 30. The electrocatalytic unit 40 releases electrons and charges into the battery jar unit 30, so as to catalyze the oxidation reaction and reduction reaction in the battery jar unit 30. When the electrocatalytic unit 40 releases charges into the battery jar unit 30, an electrolytic oxidation reaction occurs in the battery jar unit 30 to cause a potential difference between the anode 32 and the cathode 33 of the battery jar unit 30. And, when the electrocatalytic unit 40 releases electrons, a negative electrochemical damping effect occurs, enabling a reverse electrolytic reduction reaction to occur in the battery jar unit 30 and cause a potential difference between the anode 32 and the cathode 33 of the battery jar unit 30. Due to the negative electrochemical damping effect that causes a reduction reaction, a closed-loop physical resonance circuit is formed in the battery jar unit 30 to thereby achieve a one-hundred percent zero-pollution and zero-emission renewable or green energy source. Wherein, the charges and electrons released by the electrocatalytic unit 40 have a 180-degree phase difference between them.

The buffer battery unit 60 is a rechargeable battery that can be repeatedly charged and discharged. The rectifying and charging unit 50 converts alternating current (AC) potential output by the battery jar unit 30 into direct current (DC) potential, and supplies the DC potential to the buffer battery unit 60 for charging same.

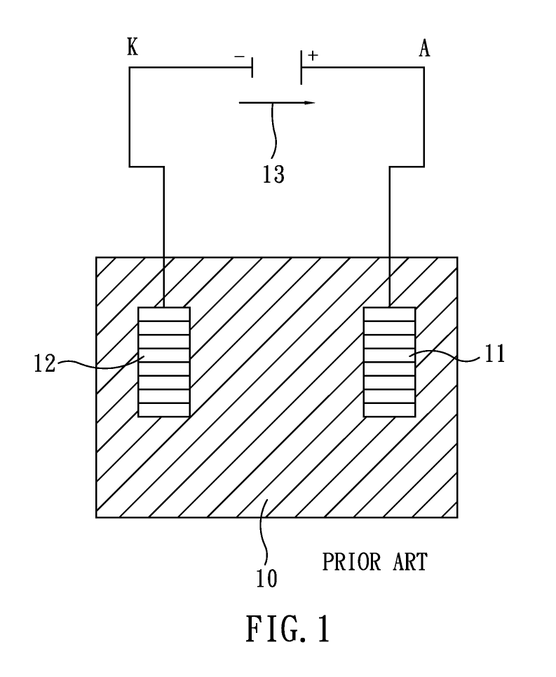

In the case of the known zinc-air fuel cell stack, the reverse electrolytic oxidation reaction shown in FIG. 1 is a charge reaction as below:

2Zn+O₂→2ZnO Ec−Ea=1.22PV

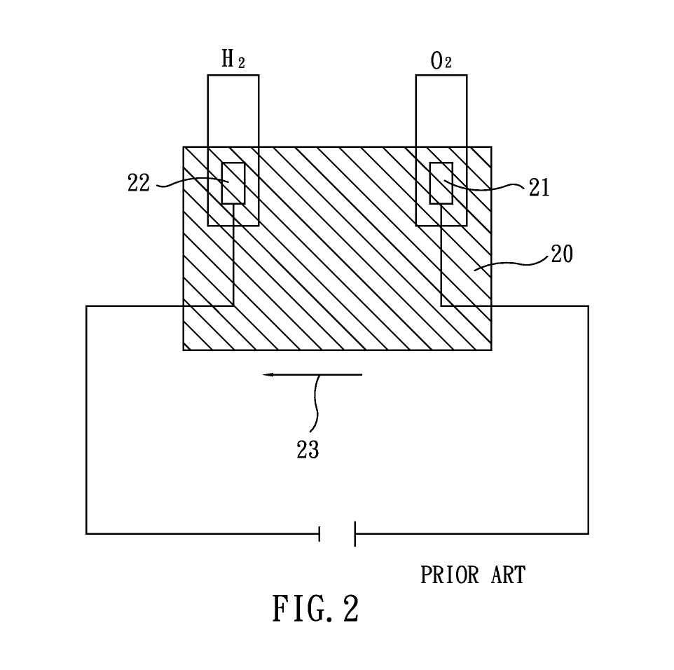

And, the electrolytic reduction reaction showing in FIG. 2 is a charge reaction as below:

2H₂O→2H₂+O₂

The present invention combines the above two charge reactions for them to occur in the same one battery jar unit 30, as shown in FIG. 4. The electrolyte 31 is changed to neutral seawater, and the chemical oxidation and reduction reactions (i.e. electrolysis) are changed to ionization that is a physical reaction. That is, the charge phase and the discharge phase have a 180-degree phase difference between them, and are effected in the same one battery jar unit 30. In the case of the known zinc-Air fuel cell stack, the anode 32 is zinc metal and the cathode 33 can be a carbon material capable of inhaling oxygen (O₂). When the battery jar unit 30 receives electrons, a reverse electrolytic reduction reaction occurs in the battery jar unit 30 to cause a potential difference between the anode 32 and the cathode 33 of the battery jar unit 30. The reactions are represented by the following chemical equations:

Anode: Zn+2OH−→ZnO+H₂O+2e− Ea: 0V

Cathode: O₂+2H₂O+4e−→4OH− Ec: 1.22PV

Charge reaction: 2Zn+O₂→1ZnO Ec−Ea=1.22PV

On the other hand, when the battery jar unit 30 receives charges (positive electricity), a reverse electrolytic oxidation reaction occurs in the battery jar unit 30 to cause a potential difference between the cathode 33 and the anode 32 of the battery jar unit 30. The reactions are represented by the following chemical equations:

Anode: ZnO+H⁺→Zn+H₂O+2c⁺ Ea: 1.22PV

Cathode: O₂+H₂O+c⁺→H⁺ Ec: 0V

Charge reaction: 2ZnO→Zn+O₂ Ec−Ea=−1.22PV

As having been mentioned above, the electrocatalytic unit 40 is able to release electrons or charges into the battery jar unit 30 to thereby activate the oxidation reaction or the reduction reaction in the battery jar unit 30. Thus, the electrons and the charges released from the electrocatalytic unit 40 are catalysts of the above-mentioned reduction reaction and oxidation reaction, respectively.

Electricity is discharged in the catalytic processes of both the above-mentioned discharge reaction and charge reaction; the electricity discharged in the discharge reaction and the electricity discharged in the charge reaction are opposite in polarity; and there is a 180-degree phase difference between the charge phase and the discharge phase, which is controlled by the electrocatalytic unit 40. That is, AC current is produced. The produced AC current is then converted by the rectifying and charging unit 50 into DC current, which can be supplied to the buffer battery unit 60 for charging same.

Since the present invention places emphasis on physical reaction (i.e. ionization), an ion generator is required to complete the reaction. In the present invention, the electrocatalytic unit 40 is the required ion generator. The electrocatalytic unit 40 is able to release charges (i.e. positive ions) into the battery jar unit 30 to cause a charging effect in the latter. The electrocatalytic unit 40 is also able to release electrons (i.e. negative ions) into the battery jar unit 30 to cause a discharging effect in the latter. The electrocatalytic unit 40 can be referred to as an electrochemical damper. In the present invention, the electrocatalytic unit 40 includes a pulse generator 41, a charge release circuit 42, and an electron release circuit 43. The pulse generator 41 is able to generate positive and negative pulses. The positive pulse activates the charge release circuit 42 to release charges, and the negative pulse activates the electron release circuit 43 to release electrons. The electron release circuit 43 includes a transistor 431 for converting frequency into electrons, an electrical damping resonant tank 432, and a booster transformer 433. The charge release circuit 42 includes a transistor 421 for converting frequency into charges, an electrical damping resonant tank 422, and a booster transformer 423. The transformer 433 of the electron release circuit 43 can output electrons at a negative ion output terminal 434, and the transformer 423 of the charge release circuit 42 can output charges at a positive ion output terminal 424. And, the transformers 433, 423 both output a neutral potential at a common neutron potential terminal 44. Since the charging in the oxidation reaction and the discharging in the reduction reaction in electrochemistry must achieve charge conservation to be equivalent to the resonance effect in physics, it is necessary to apply the technique of infinite-order resonant tank, which is disclosed in Taiwan Patent No. 098128110 entitled “Super Inductor for Infinite-order Resonant Tank” granted to the same applicant, to the resonant tanks 422, 432 in the present invention for them to complete the positive electrochemical reaction and the negative electrochemical reaction. This process is referred to as electrocatalysis. Power needed by the electrocatalytic unit 40 can be supplied from points P and N of the buffer battery unit 60. Electrons output by the electrocatalytic unit 40 can serve as a strong oxidizing agent and the charges output by the electrocatalytic unit 40 can serve as a strong reducing agent. The electron (negative ion) output terminal 434 and the charge (positive ion) output terminal 424 of the electrocatalytic unit 40 are extended into the battery jar unit 30, and an electrode 34 made of carbon nanotubes, which are a dielectric material emitting intense electron current, is connected to the electrocatalytic unit 40. When the positive and the negative booster transformer 423, 433 are off, an anti-electromotive force is induced. The induced anti-electromotive force resonates via the resonance tanks and the pulse generator 41 that generates positive and negative pulses, so that the quantity of ions produced can be controlled. Meanwhile, the resonance tanks 432, 422 can absorb the anti-electromotive force produced by the pulse generator 41 to enable stable operation of the electron release circuit 43 and the charge release circuit 42.

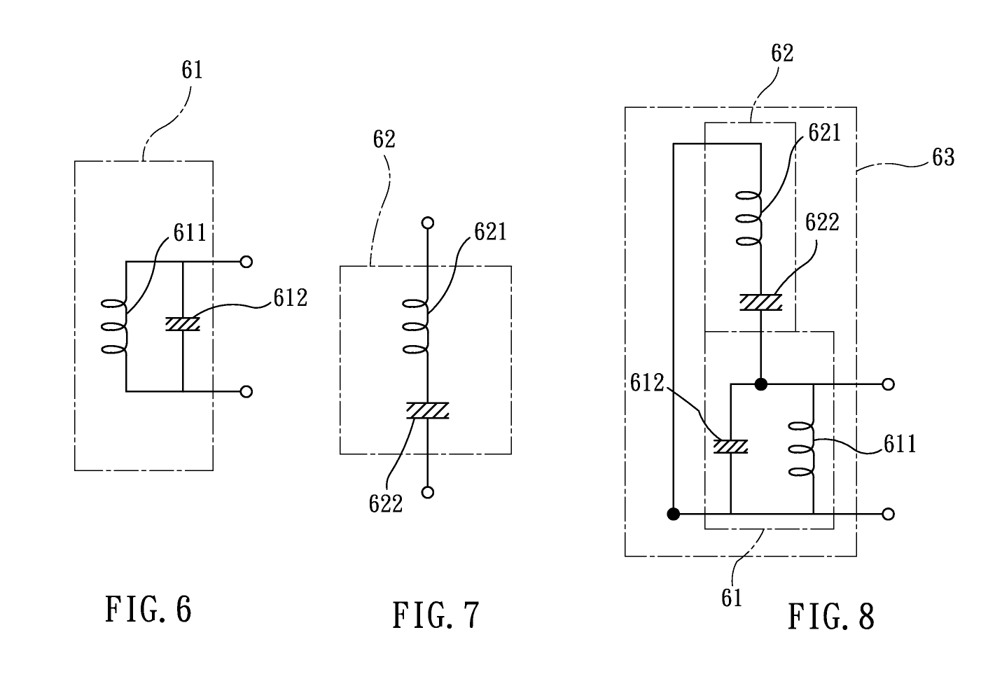

The buffer battery unit 60 can be a rechargeable acid battery 61 as shown in FIG. 6. The rechargeable acid battery 61 is composed of an equivalent inductor 611 and a capacitor 612, and is of a parallel resonance circuit. Alternatively, the buffer battery unit 60 can be a rechargeable alkaline battery 62 as shown in FIG. 7. The rechargeable alkaline battery 62 is composed of an equivalent inductor 621 and a capacitor 622, and is of a series resonance circuit. And, the buffer battery unit 60 may also be a resonant battery 63 formed by parallelly connecting the rechargeable acid battery 61 of FIG. 6 and the rechargeable alkaline battery 62 of FIG. 7, a shown in FIG. 8.

The charging and discharging behaviors in the known zinc-air battery all are chemical behaviors and that is why electrolysis and reverse electrolysis could not occur in the same one battery jar unit at the same time. In the process of oxidation and reduction reactions, an electrolytic solution, such as potassium hydroxide (KOH), directly participates in the reactions. In the case the absorption of carbon dioxide (CO₂) occurs, poisoning and failure of the fuel cell stack would occur. Or, in the case the electrolytic solution is directly changed to a sodium chloride solution, chlorine, which is a poisoning gas, and sodium hydroxide (NaOH) will be produced in the process of electrolysis. However, in the oxidation (charge) reaction and the reduction (discharge) reaction according to the present invention, the electrolyte 31 is only used in physical reaction and does not participate in any chemical reaction. The electrolyte 31 does not include pure water, but can be neutral seawater solution. No hazardous gas would be produced in the oxidation and reduction reactions because the electrolyte 31 does not involve in any chemical reaction (i.e. electrolysis). The cathode 33 can be made of a material that does not participate in the reactions, such as graphite, carbon rod, carbon nanotubes, carbon fibers, etc. The metal anode 32 can be made of a metal material other than lithium, which easily chemically reacts with seawater. For example, the metal anode 32 can be made of copper or zinc. Alternatively, the metal anode 32 can be partially made of a lithium alloy. In the case of using physical reactions in the battery, the capacity density of the battery is determined by ions. Thus, so long as the ion solubility increases, the capacity density also increases even if the battery volume is reduced.

In brief, the battery device of the present invention utilizes oxidation and reduction reactions to produce electric potential. The battery device of the present invention employs the negative electrochemical damping effect produced by the electrocatalytic unit to cause the reduction reaction, so that a closed-loop physical resonance circuit is formed in the battery jar unit. Since chemical changes are replaced by physical reactions in the battery of the present invention, a one-hundred percent zero-pollution and zero-emission renewable or green energy source can be achieved. Moreover, the AC potential produced in the present invention through oxidation (charging) reaction and reduction (discharging) reaction can be converted by the rectifying and charging unit into DC potential, which is then supplied to the buffer battery unit for charging same, allowing the present invention to provide increased benefit of self-power generation.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A battery device utilizing oxidation and reduction reactions to produce electric potential, comprising:
a battery jar unit including a salt solution as an electrolyte, an anode formed of a metal that does not chemically react with the electrolyte, and a cathode formed of an electrically conductive carbon material having breathing pores; and the carbon material being able to breathe air and to release negative hydroxide ions when the air dissolves in the electrolyte;
an electrocatalytic unit being a catalyst producing electrochemical damping effect and being used to catalyze oxidation reaction and reduction reaction in the battery jar unit; the electrocatalytic unit including a pulse generator, an electron release circuit, and a charge release circuit; the pulse generator being able to generate positive and negative pulses, the positive pulse activating the charge release circuit to release charges, and the negative pulse activating the electron release circuit to release electrons; whereby when the electrocatalytic unit releases electrons into the battery jar unit, a reverse electrolytic reduction reaction occurs in the battery jar unit to cause a potential difference between the anode and the cathode of the battery jar unit, and when the electrocatalytic unit releases charges into the battery jar unit, an electrolytic oxidation reaction occurs in the battery jar unit to cause a potential difference between the anode and the cathode of the battery jar unit;
a buffer battery unit being a rechargeable battery that can be repeatedly charged and discharged; and
a rectifying and charging unit capable of converting AC potential output by the battery jar unit into DC potential, and supplying the DC potential to the buffer battery unit for charging same.

2. The battery device utilizing oxidation and reduction reactions to produce electric potential as claimed in claim 1, wherein the chemical damping effect of the electrons released by the electrocatalytic unit causes oxidation reaction and generation of electricity, and the chemical damping effect of the charges released by the electrocatalytic unit causes reduction reaction and generation of electricity.

3. The battery device utilizing oxidation and reduction reactions to produce electric potential as claimed in claim 1, wherein the charges and the electrons released by the electrocatalytic unit have a 180-degree phase difference between them.

4. The battery device utilizing oxidation and reduction reactions to produce electric potential as claimed in claim 1, wherein the electron release circuit of the electrocatalytic unit includes a transistor for converting frequency into electrons, an electrical damping resonant tank, and a booster transformer.

5. The battery device utilizing oxidation and reduction reactions to produce electric potential as claimed in claim 1, wherein the charge release circuit of the electrocatalytic unit includes a transistor for converting frequency into charges, an electrical damping resonant tank, and a booster transformer.

6. The battery device utilizing oxidation and reduction reactions to produce electric potential as claimed in claim 1, wherein the metal for forming the anode of the battery jar unit is selected from the group consisting of copper, zinc, and lithium alloy.

7. The battery device utilizing oxidation and reduction reactions to produce electric potential as claimed in claim 1, wherein the carbon material for forming the cathode of the battery jar unit is selected from the group consisting of graphite, carbon rod, carbon nanotubes, and carbon fibers.

8. The battery device utilizing oxidation and reduction reactions to produce electric potential as claimed in claim 1, wherein the electrolyte in the battery jar unit is neutral seawater.

9. The battery device utilizing oxidation and reduction reactions to produce electric potential as claimed in claim 1, wherein the buffer battery unit is selected from the group consisting of a rechargeable acid battery and a rechargeable alkaline battery.

10. The battery device utilizing oxidation and reduction reactions to produce electric potential as claimed in claim 1, wherein the buffer battery unit is a resonant battery formed by parallelly connecting a rechargeable acid battery and a rechargeable alkaline battery.

11. The battery device utilizing oxidation and reduction reactions to produce electric potential as claimed in claim 1, wherein the rectifying and charging unit is an AC to DC converter.

12. The battery device utilizing oxidation and reduction reactions to produce electric potential as claimed in claim 1, wherein the electrocatalytic unit obtains its operating power from the buffer battery unit.
